(19) United States
(12) Patent Application Publication
(10) Pub. No.: US 2016/0221478 A1
(43) Pub. Date: Aug. 4, 2016

(54) SEAT RECLINER

(71) Applicant: FUJI KIKO Co., Ltd., Kosai-shi (JP)

(72) Inventors: Kunihisa SUGIMOTO, Shizuoka (JP); Hironori OHBA, Shizuoka (JP)

(73) Assignee: FUJI KIKO Co., Ltd., Kosai-shi (JP)

(21) Appl. No.: 15/008,517

(22) Filed: Jan. 28, 2016

(30) Foreign Application Priority Data
Feb. 2, 2015 (JP) 2015-018253

(51) Int. Cl. B60N 2/20; A47C 7/40

(52) U.S. Cl. CPC B60N 2/20; A47C 7/40

(57) ABSTRACT

A seat recliner includes a disk-shaped outer case provided with a ring-shaped protrusion that is formed along a circumference thereof and is protruded in a thickness direction thereof, a disk-shaped inner case provided inside the ring-shaped protrusion rotatably in a circumferential direction thereof, a ring-shaped holder covering outer circumferential surfaces of the outer and inner cases to restrict displacement of the inner case so as to be distanced from the outer case, and an escape portion formed by depressing one of an opening edge portion on an inner circumferential surface of the ring-shaped protrusion and a portion, on an outer circumferential surface of the inner case, facing to the opening edge portion to be distanced from another of the opening edge portion and the portion facing to the opening edge portion.

### CROSS-REFERENCE TO RELATED APPLICATIONS

The present application claims benefit of priority under 35 U.S.C. §119 to Japanese Patent Application No. 2015-18253 filed in Japan on Feb. 2, 2015, which is hereby incorporated by reference.

### BACKGROUND OF THE INVENTION

1. Technical Field

The present invention relates to a seat recliner that enables of adjusting and holding a seatback position at an inclined angle desired by a passenger.

2. Background Arts

A Patent Documents 1 (Japanese Patent Application Publication No. 2008-154992) discloses a seat recliner 101 as shown in FIG. 7. The seat recliner 101 includes a base member 110 that is fixed with a seat cushion (not shown in FIG. 7) as a seating portion, and a rotatable member 120 that is fixed with a seatback (not shown in FIG. 7) rotatably supported by the seat cushion so as to be rotatable relatively to the base member 110. A ring-shaped protrusion 111 protruding in an axial direction of a rotary shaft 142 is formed annularly on a circumference of the base member 110. The rotatable member 120 has an almost circular disk shape, and is disposed rotatably within the ring-shaped protrusion 111 of the base member 110. In addition, a lock mechanism 140 is provided in an accommodation space 127 formed between the base member 110 and the rotatable member 120. The seatback is adjusted to a desired inclined angle by rotating the rotary shaft 142 after unlocking the lock mechanism 140, and then the seatback is held at the desired inclined angle by locking the lock mechanism 140.

### SUMMARY OF THE INVENTION

In the seat recliner disclosed in the above Patent Document 1, when the rotatable member 120 is displaced in the axial direction or displaced in a separation manner so as to be peeled off from the base member 110 according to magnitude and a direction of a load caused by a passenger's reclining onto the seatback, noises may occur due to scratching between a ridge 115 of an opening edge portion 114 of the ring-shaped protrusion 111 and an outer circumferential surface 124 of the rotatable member 120.

An object of the present invention is to provide a seat recliner that can prevent noises caused by passenger's reclining onto a seatback.

An aspect of the present invention provides A seat recliner comprising: an outer case that has an almost circular disk shape and is provided with a ring-shaped protrusion that is formed along a circumference thereof and is protruded in a thickness direction thereof; an inner case that as an almost circular disk shape and is provided inside the ring-shaped protrusion rotatably in a circumferential direction thereof; a holder that has an almost circular ring shape and covers outer circumferential surfaces of the outer and inner cases to restrict displacement of the inner case so as to be distanced from the outer case; and an escape portion that is formed by depressing one of an opening edge portion on an inner circumferential surface of the ring-shaped protrusion and a portion, on an outer circumferential surface of the inner case, facing to the opening edge portion to be distanced from another of the opening edge portion and the portion facing to the opening edge portion.

According to the aspect, by providing the escape portion, the opening edge portion of the ring protrusion is prevented from contacting with the outer circumferential surface of the inner case. Therefore, even if the inner case is displaced in its thickness direction or in its radial direction or displaced in a separation manner so as to be peeled off from the outer case according to magnitude and a direction of an input load, sticking of the opening edge portion with the outer circumferential surface of the inner case never occurs and thereby noise generation can be prevented.

It is preferable that the escape portion is formed on the outer circumferential surface of the inner case at the portion facing to the opening edge portion.

In this case, a width within which an inner circumferential surface of the ring-shaped protrusion slidably contacts with the outer circumferential surface of the inner case can be made larger than that in a case where the escape portion is formed at the opening edge portion on the inner circumferential surface of the ring-shaped protrusion. Therefore, rotations of the inner case within the ring-shaped outer circumferential portion can be made stable, and stability in strength and prevention of rattling can be also achieved.

It is preferable that a sloped portion is formed between the outer circumferential surface of the inner case and the escape portion, and the outer circumferential surface, the sloped portion and the escape portion form a smoothly continuous surface.

In this case, the above-mentioned sticking of the opening edge portion with the outer circumferential surface of the inner case can be further avoided and thereby the noise generation can be further prevented.

### BRIEF DESCRIPTION OF THE DRAWINGS

FIG. 1 is a front view of a seat recliner according to a first embodiment;

FIG. 2 is a cross-sectional view taken along a line II-II shown in FIG. 1;

FIG. 3 is an enlarged cross-sectional view of a portion III shown in FIG. 2;

FIG. 4 is an enlarged cross-sectional view according to a modified example of the first embodiment, and shows a portion corresponding to the portion III shown in FIG. 2;

FIG. 5 is an enlarged cross-sectional view according to a second embodiment, and shows a portion corresponding to the portion III shown in FIG. 2;

FIG. 6 is an enlarged cross-sectional view according to a third embodiment, and shows a portion corresponding to the portion III shown in FIG. 2; and

FIG. 7 is a cross-sectional view of a prior-art seat recliner.

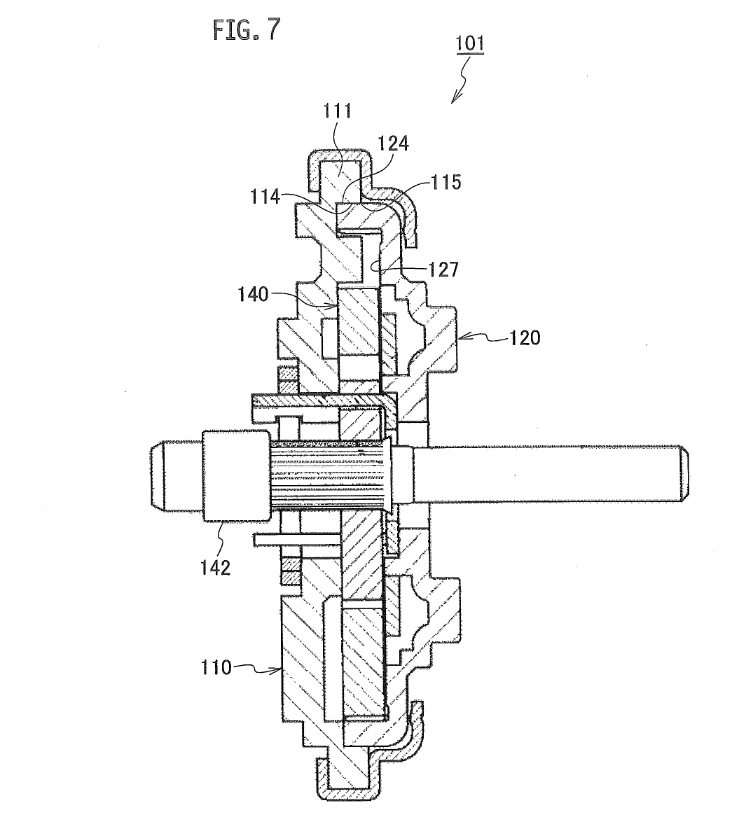

### DESCRIPTION OF THE EMBODIMENT

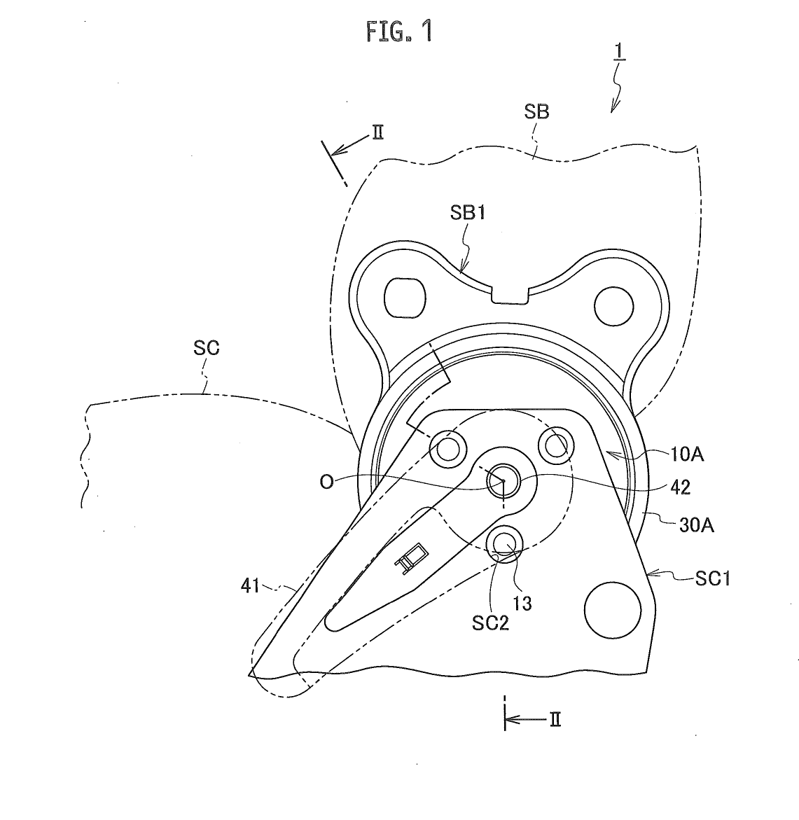

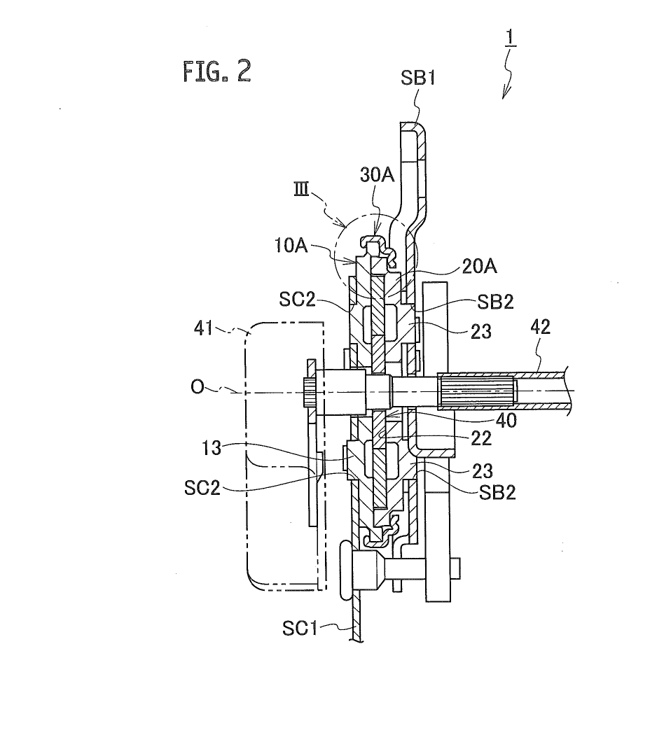

Hereinafter, embodiments will be described with reference to the drawings. As shown in FIGS. 1 to 3, a seat recliner 1 according to a first embodiment includes a base member 10A that is fixed with a seat cushion SC, a rotatable member 20A that is fixed with a seatback SB so as to be rotatable relatively to the base member 10A, a holder 30A that has a circular ring shape and covers outer circumferential surfaces of the base member 10A and the rotatable member 20A to restrict their displacements in an axial direction of a rotary shaft 42, and a lock mechanism 40 that controls rotations of the rotatable member 20A relative to the base member 10A.

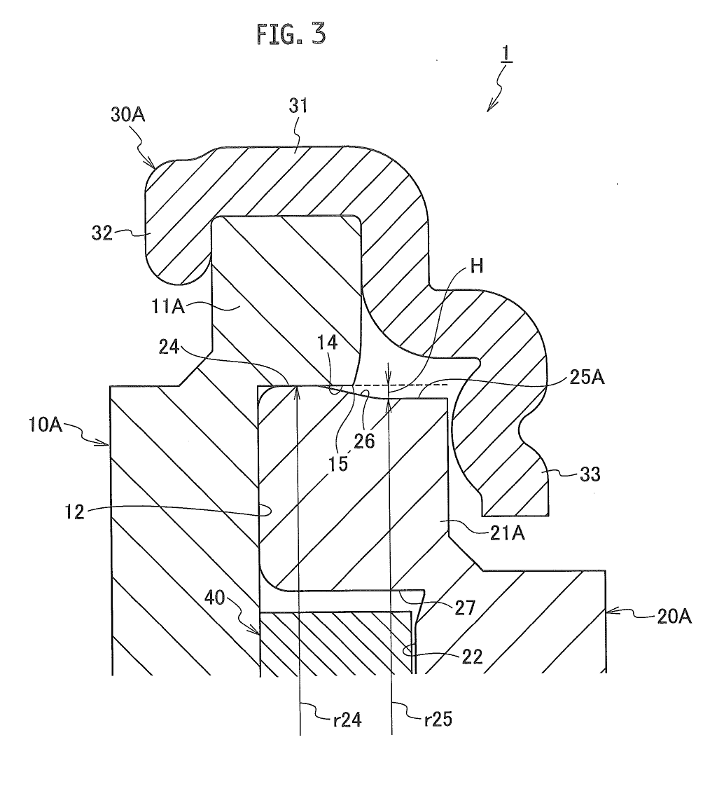

The base member 10A (outer case) has an almost circular disk shape. In addition, a ring-shaped outer circumferential portion 11A (ring-shaped protrusion) that is protruded in a thickness direction is formed on a circumference of the base member 10A, and a circular depressed portion 12 (see FIG. 3) is formed inside the ring-shaped outer circumferential portion 11A. The ring-shaped outer circumferential portion 11A and the circular depressed portion 12 are formed by half-blanking during press-working of the base member 10A. Further, base-side fixation protrusions 13 that are protruded to a rear-surface side of the circular depressed portion 12 (to its plate outer-surface side) are also formed by half-blanking the circular depressed portion 12 during press-working of the base member 10A. The base member 10A and a base plate SC1 are integrated with each other by inserting the base-side fixation protrusions 13 into base-side fixation holes SC2 opened on the base plate SC1 and then welding them together. Furthermore, the base member 10A is fixed with the seat cushion SC via the base plate SC1.

The rotatable member 20A (inner case) has an almost circular disk shape one-size smaller than the almost circular disk shape of the base member 10A, and disposed in the circular depressed portion 12 of the ring-shaped outer circumferential portion 11A coaxially with the circular depressed portion 12 of the ring-shaped outer circumferential portion 11A (with the base member 10A) so as to be rotatable relatively to the circular depressed portion 12 of the ring-shaped outer circumferential portion 11A (to the base member 10A). In addition, a ring-shaped slidably-contact portion 21A that is protruded in the thickness direction is formed on a circumference of the rotatable member 20A, and an accommodation depressed portion 22 is formed inside the ring-shaped slidably-contact portion 21A. The ring-shaped slidably-contact portion 21A and the accommodation depressed portion 22 are formed by half-blanking during press-working of the rotatable member 20A. Further, rotatable-side fixation protrusions 23 that are protruded to a rear-surface side of the accommodation depressed portion 22 (to its plate outer-surface side) are also formed by half-blanking the accommodation depressed portion 22 during press-working of the rotatable member 20A. The rotatable member 20A and a rotatable plate SB1 are integrated with each other by inserting the rotatable-side fixation protrusions 23 into rotatable-side fixation holes SB2 opened on the rotatable plate SB1 and then welding them together. Furthermore, the rotatable member 20A is fixed with the seatback SB via the rotatable plate SB1.

As shown in FIG. 3, an escape portion 25A is formed on the outer circumferential surface 24 of the rotatable member 20A from its portion facing to an opening edge portion 14 toward its plate outer-surface. The escape portion 25A is formed so that its diameter r25 from a center O of the rotatable member 20A to the escape portion 25A is made smaller than a diameter r24 from the center O to the outer circumferential surface 24. In addition, the diameter r25 of the escape portion 25A is made constant so that the escape portion 25A is made parallel to the outer circumferential surface 24. Namely, the escape portion 25A is formed by depressing the portion, on the outer circumferential surface 24, facing to the opening edge portion 14 to be distanced from the opening edge portion 14. Therefore, a gap H is formed between the opening edge portion 14 and the escape portion 25A.

Note that the gap H is set to 0.2 to 0.5 mm or so. A width of the escape portion 25A in the thickness (axial) direction is set so that, even if the rotatable member 20A (inner case) is displaced from the base member 10A (outer case) in the above-explained separation manner, the opening edge portion 14 of the ring-shaped outer circumferential portion 11A (ring-shaped protrusion) doesn't contact with the outer circumferential surface 24.

In addition, a sloped portion 26 is formed between the outer circumferential surface 24 and the escape portion 25A. The sloped portion 26 is formed as a tapered inclined (curved) surface with which the outer circumferential surface 24 and the escape portion 25A forms a smoothly continuous surface.

The holder 30A has an almost ring shape, and includes a main body 31 wound around the outer circumferential surface of the base member 10A, a base-side restriction portion 32 that is expanded from one end of the main body 31 and engaged with an outer-side surface of the circumference of the base member 10A, and a rotatable-side restriction portion 33 that is engaged with an outer-side surface of the circumference of the rotatable member 20A. By the base-side restriction portion 32 and the rotatable-side restriction portion 33, the rotatable member 20A is held rotatably while being restricted from being displacing so as to be distanced from the base member 10A.

The lock mechanism 40 is disposed in the accommodation space 27 formed between the circular depressed portion 12 of the base member 10A and the accommodation depressed portion 22 of the rotatable member 20A. The lock mechanism 40 is configured to lock or unlock rotations of the rotatable member 20A relative to the base member 10A by rotating the rotary shaft 42 located at the center O of the rotatable member 20A by use of an operational lever 41.

Next, production processes of the above components will be explained. With respect to the base member 10A, the ring-shaped outer circumferential portion 11A is formed by half-blanking a center portion of a circular disk plate during press-working for making the base member 10A. As the result, the ring-shaped outer circumferential portion 11A is formed along an outer circumference of the disk plate (the base member 10A), and the circular depressed portion 12 is formed inside the ring-shaped outer circumferential portion 11A. Subsequently (or concurrently), the base-side fixation protrusions 13 are formed by half-blanking the circular depressed portion 12 to protrude the base-side fixation protrusions 13 to the plate outer-surface side of the disk plate (to the rear-surface side of the circular depressed portion 12). In this manner, production of the base member 10A is completed.

Note that compressive stresses apply to portions near the half-blanked portions when forming the ring-shaped outer circumferential portion 11A and the base-side fixation protrusions 13. Therefore, the compressive stresses may develop when the base-side fixation protrusions 13 are welded to the base plate SC1 (the base-side fixation holes SC2), and thereby the base member 10A may get distorted. Especially, the compressive stresses may develop so as to incline the ring-shaped outer circumferential portion 11A slightly inward (i.e. toward the circular depressed portion 12).

Also with respect to the rotatable member 20A, the ring-shaped slidably-contact portion 21A is formed by half-blanking a center portion of a circular disk plate during press-working for making the rotatable member 20A. As the result, the ring-shaped slidably-contact portion 21A is protruded along an outer circumference of the disk plate (the rotatable member 20A), and the accommodation depressed portion 22 is formed inside the ring-shaped slidably-contact portion 21A. Subsequently (or concurrently), the rotatable-side fixation protrusions 23 are formed by half-blanking the accommodation depressed portion 22 to protrude the rotatable-side fixation protrusions 23 to the plate outer-surface side of the disk plate (to the rear-surface side of the accommodation depressed portion 22). Next, the rotatable member 20A is quenched in order to improve its strength. By quenching, the rotatable member 20A may be distorted slightly. However, the rotatable member 20A that remains distorted cannot rotate smoothly. Therefore, the outer circumferential surface 24 of the rotatable member 20A is reshaped to have a precisely-circular shape by a turning process. The sloped portion 26 and the escape portion 25A are also formed by cutting in this turning process for the outer circumferential surface 24. In this manner, production of the rotatable member 20A is completed.

Next, assembling processes of the seat recliner 1 will be explained. Components that constitute the lock mechanism 40 are set at predetermined positions within the circular depressed portion 12 of the base member 10A, and then the rotatable member 20A is put on the base member 10A (and the components of the lock mechanism 40). Subsequently, the holder 30A is attached, from a side of the rotatable member 20A, to the outer circumference of the base member 10A that is preliminarily assembled with the rotatable member 20A and the lock mechanism 40, and thereby the holder 30A is swaged to form the base-side restriction portion 32. As the result, the rotatable member 20A is held by the base member 10A so that the rotatable member 20A can rotate relatively to the base member 10A. Then, the base-side fixation protrusions 13 of the base member 10A are welded with the base-side fixation holes SC2 of the base plate SC1 to integrate the base member 10A with the base plate SC1. Similarly, the rotatable-side fixation protrusions 23 of the rotatable member 20A are welded with the rotatable-side fixation holes SB2 of the rotatable plate SB1 to integrate the rotatable member 20A with the rotatable plate SB1. In this manner, assembling of the seat recliner 1 is completed. With respect to the assembled seat recliner 1, the base plate SC1 is fixed with the seat cushion SC, and the rotatable plate SB1 is fixed with the seatback SB.

As already explained, a seat recliner that isn't provided with the escape portion 25A and the sloped portion 26 of the present embodiment may generate noises when a passenger reclines onto the seatback SB. Such noises are generated by the inclination of the ring-shaped outer circumferential portion 11A caused by the development of the compressive stresses. The rotatable member 20A is displaced in the axial direction and/or a radial direction of the rotary shaft 42 or displaced in the above-explained separation manner according to magnitude and a direction of a load caused by passenger's reclining onto the seatback SB. When the rotatable member 20A is displaced, noises (hitting sounds) may occur due to scratching between a ridge 15 of the opening edge portion 14 of the ring-shaped outer circumferential portion 11A and the outer circumferential surface 24 of the rotatable member 20A.

However, according to the seat recliner 1 in the present embodiment, the opening edge portion 14 of the ring-shaped outer circumferential portion 11A is prevented from contacting with the outer circumferential surface 24 of the rotatable member 20A by providing the escape portion 25A and the sloped portion 26, even if the load that causes the displacement of the rotatable member 20A in the axial direction and/or the radial direction of the rotary shaft 42 or in the above-explained separation manner is applied to the seatback SB. Therefore, even if the rotatable member 20A is displaced in the axial direction and/or the radial direction of the rotary shaft 42 or displaced in the above-explained separation manner, sticking of the ridge 15 of the opening edge portion 14 with the outer circumferential surface 24 of the rotatable member 20A never occurs and thereby the noise generation can be prevented.

In addition, by providing the escape portion 25A at the portion on the outer circumferential surface 24 of the rotatable member 20A that faces to the opening edge portion 14 of the ring-shaped outer circumferential portion 11A, a width (a height from the circular depressed portion 12 of the ring-shaped outer circumferential portion 11A) within which an inner circumferential surface of the ring-shaped outer circumferential portion 11A slidably contacts with the outer circumferential surface 24 of the rotatable member 20A can be made larger. Therefore, rotations of the rotatable member 20A within the ring-shaped outer circumferential portion 11A can be made stable, and stability in strength and prevention of rattling can be also achieved.

Further, since the outer circumferential surface 24, the escape portion 25A and the sloped portion 26 form a smoothly-continuous surface, sticking of the ridge 15 of the opening edge portion 14 with the outer circumferential surface 24 of the rotatable member 20A can be further avoided and thereby the noise generation can be further prevented.

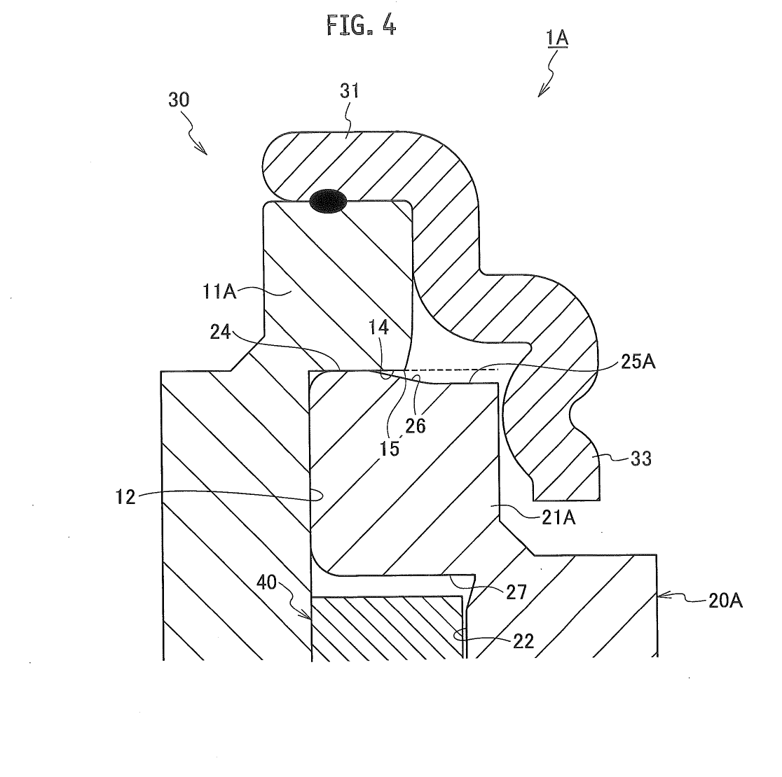

Note that, in the seat recliner 1 according to the present embodiment, the holder 30A is fixed with the base member 10A by swaging the holder 30A to form the base-side restriction portion 32. However, in a seat recliner 1A according to a modified example of the first embodiment as shown in FIG. 4, the holder 30A may be fixed with the base member 10A by fixing (e.g. laser-welding) the main body 31 with the outer circumferential surface of the ring-shaped outer circumferential portion 11A without forming the base-side restriction portion 32. According to the present modified example, the above-explained advantages achieved by the above first embodiment can be also achieved.

In the above first embodiment, the escape portion 25A is formed on the outer circumferential surface 24 of the rotatable member 20A. However, the escape portion 25A may be formed at the opening edge portion 14 of the ring-shaped outer circumferential portion 11A. According to this configuration, the above-explained advantages achieved by the above first embodiment can be also achieved.

In the above first embodiment, the diameter r25 of the escape portion 25A from the center O of the rotary shaft 42 is made constant so that the escape portion 25A is made parallel to the outer circumferential surface 24. However, the escape portion 25A is formed as a tapered surface so that the diameter r25 is made gradually reduced from a front-surface side to the rear-side surface of the base member 10A. According to this configuration, the above-explained advantages achieved by the above first embodiment can be also achieved.

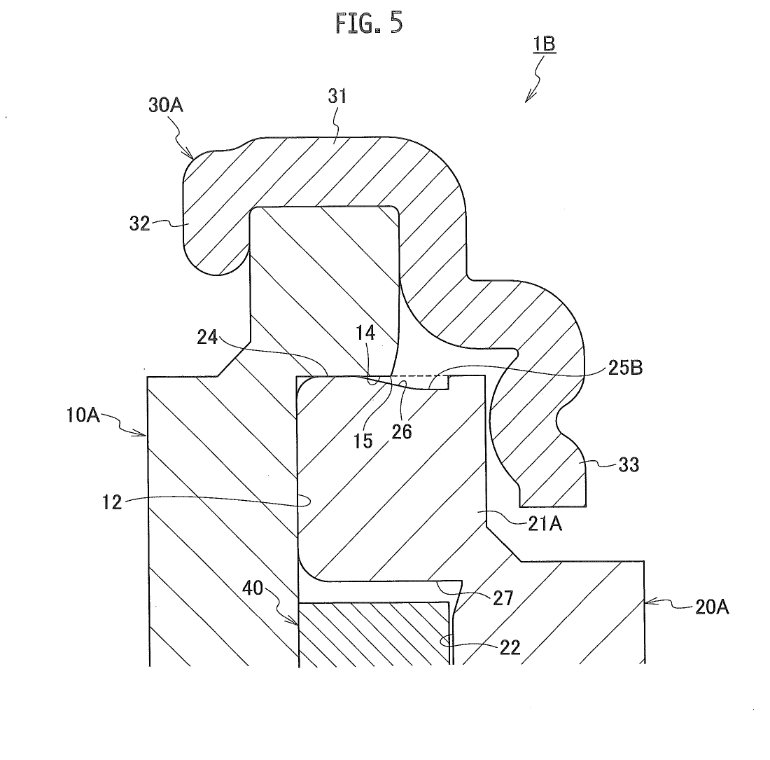

A seat recliner 1B according to a second embodiment will be explained with reference to FIG. 5. An escape portion 25B of a rotatable member 20B in the seat recliner 1B according to the present embodiment is different from the escape portion 25A in the above first embodiment. Note that elements identical or equivalent to those in the above first embodiment are labelled with identical reference numbers, and thereby their redundant explanations are omitted.

In the above first embodiment, the escape portion 25A is formed on the outer circumferential surface 24 of the rotatable member 20A from its portion facing to the opening edge portion 14 to its plate outer-surface (rear-side surface). However, the escape portion 25B in the present embodiment is formed on the outer circumferential surface 24 of the rotatable member 20A only at a portion facing to the opening edge portion 14. Namely, the escape portion 25B is formed at the middle of the outer circumferential surface 24 as a depressed groove along a circumferential direction.

According to the above-explained configuration of the escape portion 25B, the above-explained advantages achieved by the above first embodiment can be also achieved. In addition, a rear-side (plate outer-surface side) diameter of the ring-shaped slidably-contact portion 21A of the rotatable member 20A is not reduced by the escape portion 25B, so that a contact portion of the ring-shaped slidably-contact portion 21A with the rotatable-side restriction portion 33 is not made small but has a sufficient volume. Therefore, sliding stability and anti-separation strength (in the axial direction) of the base member 10A and the rotatable member 20A can be improved.

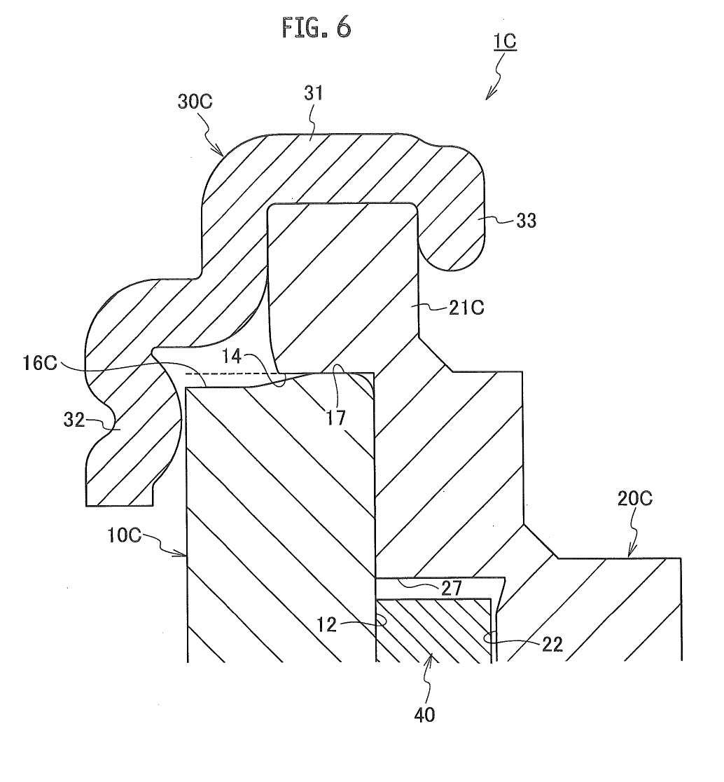

A seat recliner 1C according to a third embodiment will be explained with reference to FIG. 6. A base member 10C (as an inner case) and a rotatable member 20C (as an outer case) in the seat recliner 1C according to the present embodiment are different from the base member 10A (as an outer case) and the rotatable member 20A (as an inner case) in the above first embodiment. Namely, a ring-shaped slidably-contact portion 21C of the rotatable member 20C functions as a “ring-shaped protrusion”, and a holder 30C is swaged with an outer circumference of the ring-shaped slidably-contact portion 21C. Note that elements identical or equivalent to those in the above first embodiment are labelled with identical reference numbers, and thereby their redundant explanations are omitted.

A escape portion 16C is formed on an outer circumferential surface 17 of the base member 10C that faces an opening edge portion 14 on an inner circumferential surface of the ring-shaped slidably-contact portion 21C that is protruded in a thickness direction and formed on a circumference of the rotatable member 20C. In addition, the diameter r25 of the escape portion 16C is made constant so that the escape portion 16C is made parallel to the outer circumferential surface 17, similarly to the configuration in the above first embodiment.

According to the above-explained configuration of the escape portion 16C, the above-explained advantages achieved by the above first embodiment can be also achieved.

The present invention is not limited to the above-described embodiments, and it is possible to embody the present invention by modifying its components in a range that does not depart from the scope thereof. Further, it is possible to form various kinds of inventions by appropriately combining a plurality of components disclosed in the above-mentioned embodiments. For example, it may be possible to omit several components from all of the components shown in the above-mentioned embodiments.

What is claimed is:

1. A seat recliner comprising:
an outer case that has an almost circular disk shape and is provided with a ring-shaped protrusion that is formed along a circumference thereof and is protruded in a thickness direction thereof;
an inner case that as an almost circular disk shape and is provided inside the ring-shaped protrusion rotatably in a circumferential direction thereof;
a holder that has an almost circular ring shape and covers outer circumferential surfaces of the outer and inner cases to restrict displacement of the inner case so as to be distanced from the outer case; and
an escape portion that is formed by depressing one of an opening edge portion on an inner circumferential surface of the ring-shaped protrusion and a portion, on an outer circumferential surface of the inner case, facing to the opening edge portion to be distanced from another of the opening edge portion and the portion facing to the opening edge portion.

2. The seat recliner according to claim 1, wherein
the escape portion is formed on the outer circumferential surface of the inner case at the portion facing to the opening edge portion.

3. The seat recliner according to claim 1, wherein
a sloped portion is formed between the outer circumferential surface of the inner case and the escape portion, and
the outer circumferential surface, the sloped portion and the escape portion form a smoothly continuous surface.
